(19) United States
(12) Patent Application Publication
(10) Pub. No.: US 2026/0186515 A1
(43) Pub. Date: Jul. 2, 2026

(54) METHOD FOR CONTROLLING HOT AND COLD WATER MAT AND APPARATUS THEREOF

(71) Applicant: KYUNGDONG NAVIEN CO., LTD., Pyeongtaek-si (KR)

(72) Inventor: Jae Hwi Yang, Seoul (KR)

(21) Appl. No.: 19/429,616

(22) Filed: Dec. 22, 2025

(30) Foreign Application Priority Data
Dec. 30, 2024 (KR) 10-2024-0201107

(51) Int. Cl. G05D 11/16

(52) U.S. Cl. CPC G05D 11/16

(57) ABSTRACT

Provided is a method for controlling a hot and cold water mat. The method includes comparing a return temperature and a preset temperature, and operating a cooling part for cooling water supplied to the mat when it is determined that the return temperature is higher than the preset temperature, sensing a relative humidity and an ambient temperature, and calculating a dew point temperature by using the relative humidity and the ambient temperature, and comparing the dew point temperature and an outlet water temperature, and stopping an operation of the cooling part when it is determined that the dew point temperature is lower than the outlet water temperature.

### CROSS-REFERENCE TO RELATED APPLICATION

This application claims the benefit of priority to Korean Patent Application No. 10-2024-0201107, filed in the Korean Intellectual Property Office on Dec. 30, 2024, the entire contents of which are incorporated herein by reference.

### TECHNICAL FIELD

The present disclosure relates to a technology of controlling a hot and cold water mat, and more particularly, to a method for controlling a hot and cold water mat and an apparatus thereof, by which condensation of the hot and cold water mat may be prevented by controlling a cooling part for cooling water supplied to the mat.

### BACKGROUND

A water circulation mat refers to a mat that circulates water through passages provided in the mat to cause an appropriate temperature change. The water circulation mat may perform heating or cooling through the mat. The water circulation mat includes a hot water mat capable of heating, a cold water mat capable of cooling, and a four-season mat or a hot and cold water mat capable of both heating and cooling. The water circulation mat may include a mat part that includes a passage through which water circulates, and a body part for supplying hot or cold water to the mat part.

The hot and cold water mat is provided with both a device that heats water and a device that cools water, and condensation may occur in a hot and humid environment. Accordingly, a concerning for preventing occurrence of condensation is required.

### SUMMARY

The present disclosure has been made to solve the above-mentioned problems occurring in the prior art while advantages achieved by the prior art are maintained intact.

An aspect of the present disclosure provides a method for controlling a hot and cold water mat and an apparatus thereof, by which condensation of the hot and cold water mat may be prevented by controlling a cooling part for cooling water supplied to the mat.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a method for controlling a hot and cold water mat includes comparing a return temperature and a preset temperature, and operating a cooling part for cooling water supplied to the mat when it is determined that the return temperature is higher than the preset temperature, sensing a relative humidity and an ambient temperature, and calculating a dew point temperature by using the relative humidity and the ambient temperature, and comparing the dew point temperature and an outlet water temperature, and stopping an operation of the cooling part when it is determined that the dew point temperature is lower than the outlet water temperature.

According to an embodiment, in the operating of the cooling part, the hot and cold water mat may be operated in a cooling mode, and the cooling part may be operated when it is determined that the return temperature is higher than the preset temperature.

In addition, the method according to an embodiment may further include operating the cooling part when it is determined that the outlet water temperature is higher than the dew point temperature by a predetermined temperature or more.

According to an embodiment, the cooling part may include a thermoelectric element.

According to an embodiment, the thermoelectric element may include a Peltier element.

According to another aspect of the present disclosure, a hot and cold water mat control apparatus includes a memory that stores computer-executable instructions, and at least one processor that executes the instructions by accessing the memory, and the at least one processor may be configured to compare a return temperature and a preset temperature, and operate a cooling part for cooling water supplied to the mat when it is determined that the return temperature is higher than the preset temperature, sense a relative humidity and an ambient temperature, and calculate a dew point temperature by using the relative humidity and the ambient temperature, and compare the dew point temperature and an outlet water temperature, and stop an operation of the cooling part when it is determined that the dew point temperature is lower than the outlet water temperature.

According to an embodiment, the at least one processor may be configured to operate the hot and cold water mat in a cooling mode, and operate the cooling part when it is determined that the return temperature is higher than the preset temperature.

According to an embodiment, the at least one processor may be configured to operate the cooling part when it is determined that the outlet water temperature is higher than the dew point temperature by a predetermined temperature or more.

According to an embodiment, the cooling part may include a thermoelectric element.

According to an embodiment, the thermoelectric element may include a Peltier element.

The features of the present disclosure briefly summarized above are merely exemplary aspects described in the following detailed description of the present disclosure, and are not intended to limit the scope of the present disclosure.

### BRIEF DESCRIPTION OF THE DRAWINGS

The above and other objects, features and advantages of the present disclosure will be more apparent from the following detailed description taken in conjunction with the accompanying drawings:

FIG. 1 illustrates a structure of an embodiment of a hot and cold water mat system;

FIG. 2 illustrates an exemplary view for explaining an operation of a cooling mode in a hot and cold water mat system;

FIG. 3 illustrates an exemplary view for explaining an operation of a heating mode in a hot and cold water mat system;

FIG. 4 illustrates a flow chart of operations of a method for controlling a hot and cold water mat according to an embodiment of the present disclosure;

FIG. 5 illustrates an exemplary view for explaining a cooling part control scheme depending on a dew point temperature and an outlet water temperature;

FIG. 6 illustrates a configuration of a hot and cold water mat control apparatus according to another embodiment of the present disclosure; and

FIG. 7 illustrates a block diagram of a computing system for executing a method for controlling a hot and cold water mat according to an embodiment of the present disclosure.

### DETAILED DESCRIPTION

Hereinafter, various embodiments of the present disclosure will be described in detail with reference to the accompanying drawings, so that those skilled in the art may easily carry out the present disclosure. However, the disclosure may be embodied in many different forms and should not be construed as limited to the embodiments set forth herein.

In describing the embodiments of the present disclosure, if a specific description of the related art is deemed to obscure the subject matter of the embodiments of the present disclosure, the detailed description will be omitted. In addition, in the drawings, parts that are not related to the description of the present disclosure are omitted, and similar parts are given similar reference numerals.

In the present disclosure, it will be understood that if an element is referred to as being “connected” or “coupled” to another element, it may be directly connected or indirectly connected to another element. In addition, if some part ‘includes’ or “possess” some elements, unless explicitly described to the contrary, it means that other elements may be further included but not excluded.

In the present disclosure, expressions such as “first,” or “second,” and the like, may express their elements regardless of their priority or importance and may be used to distinguish one element from another element but is not limited to these components. Therefore, without departing from the scope of the present disclosure, a first component of one embodiment may be referred to as a second component of another embodiment. Similarly, a second component of one embodiment may be referred to as a first component of another embodiment.

In the present disclosure, components that are distinguished from each other are only for clearly describing characteristics, and do not mean that the components are necessarily separated. That is, a plurality of components may be integrated to form a single hardware or software unit, or a single component may be distributed to form a plurality of hardware or software units. Accordingly, such integrated or distributed embodiments are included in the scope of the present disclosure, even though not mentioned separately.

In the present disclosure, components described in various embodiments do not necessarily mean essential components, and some may be optional components. Therefore, an embodiment composed of a subset of components described in an embodiment is also included in the scope of the present disclosure. In addition, embodiments including other components in addition to the components described in various embodiments are also included in the scope of the present disclosure.

In the present disclosure, expressions of positional relationships used herein, such as upper, lower, left, and right are described for convenience of description. If viewing the drawings shown in this specification in reverse, the positional relationship described in the specification may be interpreted in the opposite manner.

In the present disclosure, the expressions “A or B”, “at least one of A and B”, “at least one of A or B”, “A, B, or C”, “at least one of A, B, and C”, and “at least one of A, B, or C” may include any and all combinations of one or more of the associated listed items.

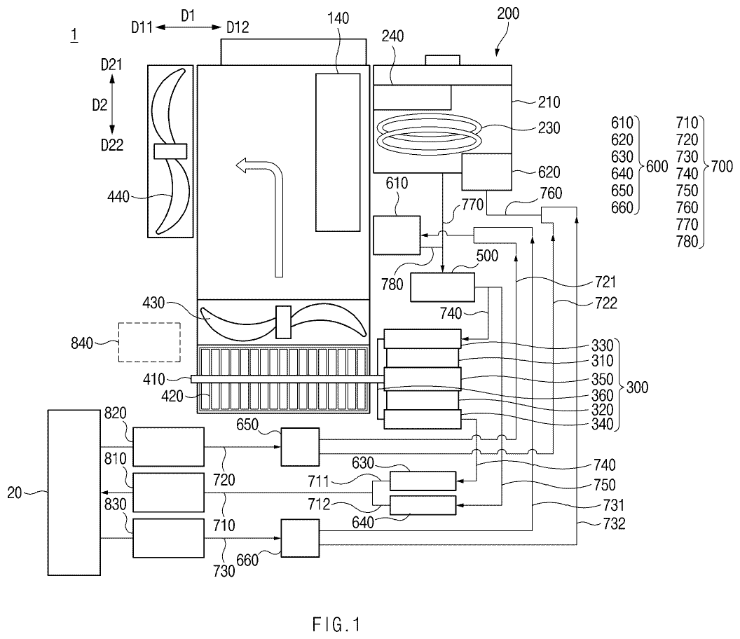

FIG. 1 illustrates a structure of an embodiment of a hot and cold water mat system.

Referring to FIG. 1, a hot and cold water mat system 1 may include a body part (not illustrated) and a mat part 20 that is connected to the body part.

The body part may supply water to the mat part 20, and water that circulates through the mat part 20 may be introduced again. Water that is returned from the mat part 20 to the body part may undergo a cooling or heating process in an interior of the body part and then be supplied again to the mat part 20. The body part is a device that processes water, and according to various embodiments, may be referred to as a water processing part.

The mat part 20 may be provided with an internal passage, in which water may flow, in an interior thereof. The internal passage may be surrounded by an outer cover that is formed of a fabric or a flexible material, and may be disposed in an interior of the outer cover in a serpentine form to uniformly supply cooling or heating to an entire area of the outer cover.

The mat part 20 may be configured such that water supplied from the body part flows along the internal passage and is returned to the body part, and then is supplied again to the internal passage via a processing process (that is, cooling or heating) in the body part. That is, the internal passage may be connected to a passage provided in an interior of the body part, and as they are connected to each other, a water circulation loop having a closed loop form may be formed.

The body part may include components that may cool or heat water returned from the mat part 20 and supply the processed water to the mat part 20.

The body part may include a case (not illustrated), a tank part 200, a cooling part 300, a heat dissipating part, a pump part 500, a plurality of valves 600, and a plurality of passages 700. However, the body part may further include other components for operating the hot and cold water mat system 1, in addition to the components described above.

Hereinafter, the components included in the body part will be described first.

### Case

The case is a component that defines an exterior of the body part, and may be provided in a shape that may accommodate other components in an interior thereof. The case may have a hexahedral shape having specific lengths in an upward/downward direction D2, a a forward/rearward direction D1, and leftward/rightward direction (e.g., a direction that is perpendicular to the upward/downward direction D2 and the forward/rearward direction D1), but the present disclosure is not limited thereto.

The tank part 200, the cooling part 300, the heat dissipating part, the pump part 500, the plurality of valves 600, and the plurality of passages 700 may be accommodated in an interior of the case.

An outer surface of the case in a forward direction D11 may be provided with a plurality of vent holes such that interior air may be discharged to the outside, and each of the vent holes may be formed in a shape of which a cross section becomes larger as it goes in the forward direction D11 to facilitate exhaust.

A water inlet (not illustrated), through which water may be injected to the tank part 200, may be provided on sides of the case, except for a side thereof in an upward direction D21.

An outer surface of the case in the forward direction D11 may be provided with a connection pipe (not illustrated), to which a connector of the mat part 20 is connected. The connection pipe may include a water outlet pipe, through which water in the body part is discharged to the mat part 20, and a first return pipe and a second return pipe, through which water of the mat part 20 is returned to the body part. For example, the hot and cold water mat system 1 may be provided with a first internal passage and a second internal passage that are separated from each other in an interior of the mat part 20, and when the connector and the connection pipe are coupled to each other, the first return pipe may be connected to the first internal passage, the second return pipe may be connected to the second internal passage, and the water outlet pipe may be connected to the first internal passage and the second internal passage (e.g., connected to each other through a Y-shaped branch connector).

### Tank Part 200

Water may be stored in an interior of the tank part 200. The tank part 200 may be supplied with water from the outside through the water inlet, and also, water returned from the mat part 20 may be stored. That is, the tank part 200 may be connected to at least a portion of return passages 720 and 730, through which water returned from the mat part 20 flows, and may be configured such that the returned water is supplied to the mat part 20 via the tank part 200.

The tank part 200 may include a base 210, in which a storage space 211 for storing water is formed, a cover that covers the base 210, a heater 230 that is disposed in an interior of the base 210 to heat water stored in the storage space, and a tank temperature sensor 240 that is disposed in the interior of the base 210 to measure a temperature of the water stored in the storage space.

The tank part 200 may be connected to the pump part 500. For example, the tank part 200 may be connected to the pump part 500 such that water in an interior of the storage space is supplied to it. The tank part 200 may be connected to at least a portion of return passages 720 and 730 such that the returned water may be stored. For example, the tank part 200 and the return passages 720 and 730 may be connected to each other by means of a first heating valve 620, and flow of water in the return passages 720 and 730 to the tank part 200 may be controlled in response to opening and closing of the first heating valve 620.

### Cooling Part 300

The cooling part 300 may be configured to cool water to be discharged to the mat part 20. The cooling part 300 may cool water delivered from the pump part 500 to a predetermined temperature and supply it to the mat part 20.

The cooling part 300 may be configured as a device that uses a thermoelectric element, for example, a Peltier element, in which temperature gradients are formed at opposite ends thereof when electric power is received.

For example, the cooling part 300 may include a first Peltier element 310, a second Peltier element 320, a first water jacket 330 that is disposed on an upper surface of the first Peltier element 310, a second water jacket 340 that is disposed on a lower surface of the second Peltier element 320, a support member 350 that is disposed between the lower surface of the first Peltier element 310 and the upper surface of the second Peltier element 320, and a connection pipe 360 that connects the first water jacket 330 and the second water jacket 340 such that they communicate with each other.

In each of the first Peltier element 310 and the second Peltier element 320, one of opposite surfaces thereof may be cooled and the remaining one may be heated as electric power is supplied. Water may be delivered close to low-temperature surfaces of the first Peltier element 310 and the second Peltier element 320 so that the water is cooled.

The first water jacket 330 and the second water jacket 340 are components that allow water to flow thereinto so that the water is cooled, and the water may flow from the first water jacket 330 to the second water jacket 340 through the connection pipe 360. The first water jacket 330 and the second water jacket 340 may contact low-temperature surfaces of the first Peltier element 310 and the second Peltier element 320 to cool water in interiors thereof.

The support member 350 may contact high-temperature surfaces of the first Peltier element 310 and the second Peltier element 320. The support member 350 is connected to the heat dissipating part to dissipate heat of the high-temperature surfaces to the heat dissipating part. That is, because the support member 350 is connected to the heat dissipating part, the high-temperature surfaces of the first Peltier element 310 and the second Peltier element 320 may be cooled.

The cooling part 300 may be operated to form temperature gradients, in which the upper surface of the first Peltier element 310 and the lower surface of the second Peltier element 320 are of relatively low temperatures, and the lower surface of the first Peltier element 310 and the upper surface of the second Peltier element 320 are of relatively high temperatures, so that water delivered into interiors of the first water jacket 330 and the second water jacket 340 may be cooled.

### Heat Dissipating Part

The heat dissipating part is a component for dissipating heat of the cooling part 300 and the PBA module 140, and may be configured to cool the cooling part 300 and the PBA module 140 by using flows of air.

The heat dissipating part may include a heat pipe 410 that is connected to a support member 350 of the cooling part 300 such that heat may be transferred therebetween, a plurality of heat dissipating fins 420 through which the heat pipe 410 passes, a first fan 430 that is disposed at an upper portion of the heat dissipating fins 420 to form flows of air in the upward direction D21, and a second fan 440 that is disposed to face the plurality of vent holes 110 to form flows of air in the forward direction D11. The heat pipe 410 and the plurality of heat dissipating fins 420 may be referred to as a heat dissipation module for dissipating heat.

The heat pipe 410 may receive heat from the high-temperature surfaces of the Peltier elements 310 and 320 while contacting the support member 350. The plurality of heat dissipating fins 420 may be arranged along the forward/rearward direction D1 while being perpendicular to the heat pipe 410, so that a heat transfer area may be increased. The first fan 430 and the second fan 440 may be disposed perpendicular to each other. For example, a plurality of blades of the first fan 430 may be rotated around an axis that is parallel to the upward/downward direction D2, and a plurality of blades of the second fan 440 may be rotated around an axis that is parallel to the forward/rearward direction D1.

In response to an operation of the first fan 430, the air introduced into an interior of the case 100 may cool the plurality of heat dissipating fins 420 and the heat pipe 410 while passing through spaces between the plurality of heat dissipating fins 420 in the upward direction D21, and heat of the high-temperature surfaces of the Peltier elements 310 and 320 may be dissipated. The air that has passed through the plurality of heat dissipating fins 420 may be exhausted to a front side through the plurality of vent holes 110 by an operation of the second fan 440, and in this process, the PBA module 140 may be cooled. By the operation of the second fan 440, the air that has passed through the plurality of heat dissipating fins 420 may not flow downward again.

For example, the air introduced by the first fan 430 primarily cools the plurality of heat dissipating fins 420 and the heat pipe 410 and secondarily cools the PBA module 140 that is located on an upper side of them, and then is discharged to the outside by the second fan 440. It may be understood that a design in which the PBA module 140 is disposed on an upper side of the heat dissipating part is applied to implement the cooling.

The above cooling method considers that a temperature of air that has absorbed heat of the plurality of heat dissipating fins 420 and the heat pipe 410 is lower than a temperature of the PBA module 140, and the air that has cooled the plurality of heat dissipating fins 420 and the heat pipe 410 may be reused for cooling of the PBA module 140 so that a cooling efficiency may be improved. For example, a temperature of air that has passed through the plurality of heat dissipating fins 420 may be about 40° C., and a temperature of the PBA module 140 may be about 80° C. to 100° C. However, the above-described numerical values are merely exemplary and are not limited thereto.

### Pump Part 500

The pump part 500 may be a device that pumps water to allow the water to flow along a passage. A flow rate of water that flows due to the pump part 500 may be controlled. The pump part 500 may be connected to the tank part 200, the cooling part 300, a water outlet passage 710, and the return passages 720 and 730.

The pump part 500 may pump water returned from the mat part 20 toward the water outlet passage 710. The pump part 500 may receive water that has been returned from the mat part 20 and has passed through a first cooling valve 610, or water that has been returned from the mat part 20 and has passed through the first heating valve 620 and the tank part 200. To cool the water that has passed through the first cooling valve 610, the water may be pumped to the cooling part 300 by the pump part 500, and the water that has passed through the first heating valve 620 and the tank part 200 to be heated may be pumped toward a second heating valve 640 by the pump part 500.

### Plurality of Valves 600

A plurality of valves 600 may be components for selectively adjusting a passage through which water flows. That is, a passage through which water flows may be determined depending on opening and closing of the plurality of valves 600.

The plurality of valves 600 may include a first cooling valve 610, a first heating valve 620, a second cooling valve 630, a second heating valve 640, a first return valve 650, and a second return valve 660.

Here, the terms “cooling valve” and “heating valve” distinguish between valves that are opened during operation in a cooling mode and valves that are opened during operation in a heating mode in the hot and cold water mat system 1 of the present disclosure, and they do not mean that cooling or heating is performed by the valves themselves.

The first cooling valve 610 may be provided at a water inlet side of the pump part 500 to adjust introduction of returned water to the pump part 500. The first heating valve 620 may be connected to the tank part 200 to adjust introduction of returned water to the tank part 200.

The second cooling valve 630 may be provided at a water outlet side of the cooling part 300 to adjust introduction of water that has passed through the cooling part 300 into the water outlet passage 710. The second heating valve 640 may be provided at a water outlet side of the pump part 500 to adjust introduction of water that has been directly pumped from the pump part 500 while not passing via the cooling part 300 into the water outlet passage 710.

The first return valve 650 may be provided at a branching point of a first return passage 720 to adjust flows of water returned through the first return passage 720 to any one of a first branched return passage 721 and a second branched return passage 722. The first branched return passage 721 may be connected to the first cooling valve 610, and the second branched return passage 722 may be connected to the first heating valve 620.

The second return valve 660 may be provided at a branching point of a second return passage 730 to adjust flows of water returned through the second return passage 730 to any one of a third branched return passage 731 and a fourth branched return passage 732. The third branched return passage 731 may be connected to the first cooling valve 610, and the fourth branched return passage 732 may be connected to the first heating valve 620.

The first return valve 650 and the second return valve 660 may block the water in interiors of the first return passage 720 and the second return passage 730 from flowing to the respective branch passages. That is, the first return valve 650 may block the water from flowing to either the first branched return passage 721 or the second branched return passage 722 from the first return passage 720. The same applies to the second return valve 660.

The hot and cold water mat system 1 may be provided with two internal passages that are separated from each other in an interior of the mat part 20, and water may be circulated in only one of the two internal passages, which corresponds to the opened return valve, by closing any one of the first return valve 650 and the second return valve 660. Accordingly, the temperature of water that flows through the two internal passages may be individually adjusted.

Although not illustrated, the internal passage may include a first internal passage (or a left internal passage) that is connected to the first return passage 720, and a second internal passage (or a right internal passage) that is connected to the second return passage 730. For example, when the flows of water to the first and second branched return passages 721 and 722 are blocked by closing the first return valve 650, and the flows to any one of the third and fourth branched return passages 731 and 732 are allowed by opening the second return valve 660, circulation of water between the first internal passage connected to the first return passage 720 and the body part is temporarily stopped because water in an interior of the first internal passage is not returned, and the returned water is circulated while being supplied again after being processed in the body part because water in an interior of the internal passage of the mat part 20 connected to the second return passage 730 is returned. Through this, temperatures of left and right portions of the mat part 20 may be individually adjusted.

### Plurality of Passages 700

The plurality of passages 700 may connect the mat part 20 (particularly, an internal passage of the mat part 20) to at least one of the tank part 200, the cooling part 300, and the pump part 500 such that water returned from the mat part 20 may be supplied to the mat part 20 again after being cooled or heated in the body part.

The plurality of passages 700 may include a water outlet passage 710, a first return passage 720, a second return passage 730, a cooling passage 740, and a heating passage 750.

The water outlet passage 710 may connect the second cooling valve 630 and the second heating valve 640 to the mat part 20. The water outlet passage 710 may be branched from one point and may be configured such that a first branched water outlet passage 711 is connected to the second cooling valve 630 and a second branched water outlet passage 712 is connected to the second heating valve 640. That is, the water that has passed through the second cooling valve 630 flows to the first water outlet passage 710 through the first branched water outlet passage 711, and the water that has passed through the second heating valve 640 flows to the first water outlet passage 710 through the second branched water outlet passage 712.

The water outlet passage 710 may be provided with an outlet temperature sensor 810 for measuring a temperature of the water that is discharged toward the mat part 20. The outlet temperature sensor 810 may be provided between an internal passage of the mat part 20 and a branching point of the branched water outlet passage 710.

The first return passage 720 may connect the first internal passage of the mat part 20 to the first cooling valve 610 and the first heating valve 620. A first return valve 650 may be provided on the first return passage 720. The first return passage 720 may be branched with respect to the first return valve 650, and may be configured such that a first branched return passage 721 is connected to the first cooling valve 610 and a second branched return passage 722 is connected to the first heating valve 620. That is, the water returned from the first internal passage through the first return passage 720 may be discharged to the first internal passage again after flowing to the first branched return passage 721 and being cooled by the cooling part 300 when cooling is necessary, and may be discharged to the first internal passage again after flowing to the second branched return passage 722 and being heated by the heater 230 when heating is necessary.

The first return passage 720 may be provided with a first return temperature sensor 820 for measuring a temperature of the water returned from the first internal passage. The first return temperature sensor 820 may be provided between the first internal passage of the mat part 20 and the first return valve 650.

The second return passage 730 may connect the second internal passage of the mat part 20 to the first cooling valve 610 and the first heating valve 620. A second return valve 660 may be provided on the second return passage 730. The second return passage 730 may be branched with respect to the second return valve 660, and may be configured such that a third branched return passage 731 is connected to the first cooling valve 610 and a fourth branched return passage 732 is connected to the first heating valve 620. That is, the water returned from the second internal passage through the second return passage 730 may be discharged to the second internal passage again after flowing to the third branched return passage 731 and being cooled by the cooling part 300 when cooling is necessary, and may be discharged to the second internal passage again after flowing to the fourth branched return passage 732 and being heated by the heater 230 when heating is necessary.

The second return passage 730 may be provided with a second return temperature sensor 830 for measuring a temperature of the water returned from the second internal passage. The second return temperature sensor 830 may be provided between the second internal passage of the mat part 20 and the second return valve 660.

The cooling passage 740 may connect the pump part 500 to the second cooling valve 630, and may extend across the cooling part 300. That is, opposite ends of the cooling passage 740 may be connected to the pump part 500 and the second cooling valve 630, and the cooling part 300 may be provided between the pump part 500 and the second cooling valve 630. Accordingly, after the water pumped by the pump part 500 is cooled in the cooling part 300, it may flow toward the second cooling valve 630, and when the second cooling valve 630 is opened, the cooled water may be discharged to the mat part 20 through the water outlet passage 710.

The heating passage 750 may be branched from the cooling passage 740 and may connect the pump part 500 to the second heating valve 640. That is, the heating passage 750 may be connected to the second heating valve 640 while communicating with the cooling passage 740 connected to the pump part 500. Accordingly, after being heated in the tank part 200, the water delivered to the pump part 500 may be pumped by the pump part 500 and flow toward the second heating valve 640, and when the second heating valve 640 is opened, the heated water may be discharged to the mat part 20 through the water outlet passage 710.

Meanwhile, because the heating passage 750 is branched from the cooling passage 740, the water pumped by the pump part 500 may flow along both the heating passage 750 and the cooling passage 740, and discharge of the water through the water outlet passage 710 is adjusted by opening and closing the second cooling valve 630 and the second heating valve 640. That is, when the returned water is cooled and discharged, the water delivered to the pump part 500 through the first cooling valve 610 may flow to both the cooling passage 740 and the heating passage 750 when being pumped by the pump part 500, but because the second heating valve 640 is maintained in a closed state, only the water that has passed through the cooling part 300 may be discharged.

The plurality of passages 700 may further include a first connection passage 770 that connects the tank part 200 to the pump part 500, and a second connection passage 780 that connects the first connection passage 770 to the first cooling valve 610. The water in the interior of the tank part 200 may flow to the pump part 500 through a first connection passage 770. The water that has passed through the first cooling valve 610 may be introduced into the first connection passage 770 through the second connection passage 780, and then, may flow to the pump part 500.

The plurality of passages 700 may further include a third connection passage 760 that connects the second branched return passage 722 and the fourth branched return passage 732 to the first heating valve 620. For example, the third connection passage 760 may be provided between a point, at which the second branched return passage 722 and the fourth branched return passage 732 are connected to each other, and the first heating valve 620. That is, opposite ends of the third connection passage 760 may be connected to a junction point of the second branched return passage 722 and the fourth branched return passage 732 and to the first heating valve 620, respectively. Accordingly, the water that flows along the second branched return passage 722 and the fourth branched return passage 732, respectively, may be delivered to the first heating valve 620 after merging in the third connection passage 760.

Furthermore, the hot and cold water mat system 1 may further include control means, for example, a processor (not illustrated), that controls respective components of the hot and cold water mat system 1. The processor may be provided in an interior of the body part, but is not limited thereto.

The processor may control the heater 230, the cooling part 300, the fans 430 and 440, the pump part 500, and the plurality of valves 600. That is, the processor may generate and provide control signals for operations of the heater 230, the cooling part 300, the fans 430 and 440, the pump part 500, and the plurality of valves 600. Furthermore, the processor may receive temperature information from the plurality of temperature sensors 240, 810, 820, and 830, and may receive relative humidity ambient temperature information a information and from temperature/humidity sensor 840. The processor may control the hot and cold water mat system 1 based on a difference between a temperature measured by the return temperature sensors 820 and 830 and a preset temperature.

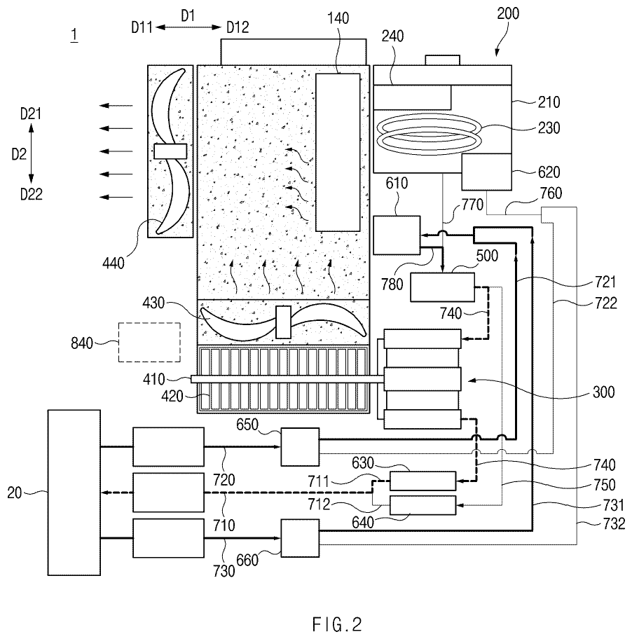

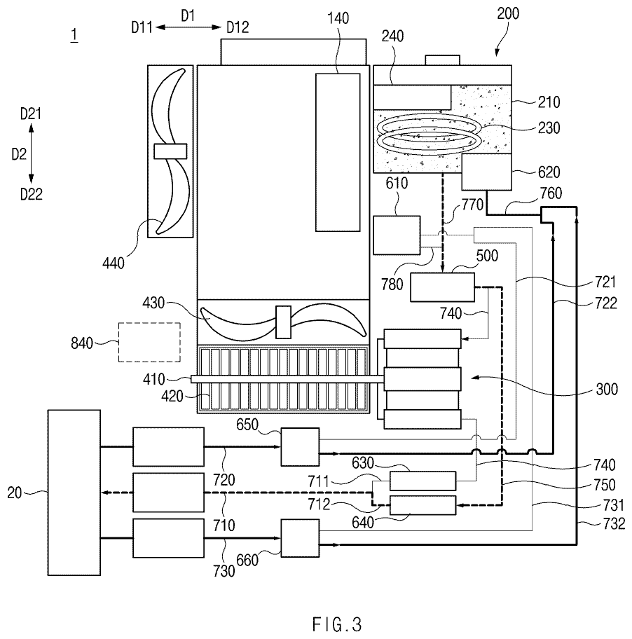

Hereinafter, operations of a cooling mode and a heating mode and circulation paths of water during the operations in the hot and cold water mat system 1 will be described with reference to FIGS. 2 and 3.

FIG. 2 illustrates an example diagram for explaining an operation of a cooling mode in the hot and cold water mat system 1, and FIG. 3 illustrates an example diagram for explaining an operation of a heating mode in the hot and cold water mat system 1.

Hereinafter, a description will be made based on water returned from the first internal passage, but this is merely for convenience of explanation, and the following description may be equally applied to water returned from the second internal passage.

### Cooling Mode

First, referring to FIG. 2, the hot and cold water mat system 1 may be operated in a cooling mode (or a cooling system) when a temperature of the mat part 20 is to be lowered. In FIG. 2, a path through which water circulates is indicated by a thick line, a path of water before being cooled after being returned is indicated by a thick solid line, and a path of cooled water is indicated by a thick dotted line.

When a temperature of the first internal passage is to be lowered, the water returned through the first return passage 720 may be delivered to the first branched return passage 721 via the first return valve 650. That is, the first return valve 650 is operated such that the water in an interior of the first return passage 720 flows to the first branched return passage 721 connected to the first cooling valve 610.

The water introduced into the first branched return passage 721 is delivered to the pump part 500 via the first cooling valve 610 as the first cooling valve 610 is opened, and, at this time, the first heating valve 620 is in a closed state. The water delivered to the pump part 500 may be pumped by the pump part 500 and delivered to the cooling part 300, and may be delivered to the second cooling valve 630 after being cooled to a predetermined temperature in the cooling part 300. The water pumped from the pump part 500 is delivered to the second cooling valve 630 via the cooling part 300 while flowing through the cooling passage 740.

The water delivered to the second cooling valve 630 may flow through the first branched water outlet passage 711 and the water outlet passage 710 as the second cooling valve 630 is opened, and may be discharged to the mat part 20. In this case, because the second heating valve 640 is in a closed state, only the water that is cooled after passing through the cooling part 300 may be delivered to the water outlet passage 710. An outlet temperature sensor 810 provided in the water outlet passage 710 may measure a temperature of the discharged water. This is to prevent overcooling of the discharged water.

That is, when a temperature of the first internal passage is lowered, the water returned from the first internal passage is discharged to the mat part 20 after sequentially passing through the first return passage 720, the first return valve 650, the first branched return passage 721, the first cooling valve 610, the pump part 500, the cooling passage 740, the cooling part 300, the cooling passage 740, the second cooling valve 630, the first branched water outlet passage 711, and the water outlet passage 710.

Likewise, even when a temperature of the second internal passage is to be lowered, the water returned from the second internal passage is discharged to the mat part 20 after sequentially passing through the second return passage 730, the second return valve 660, the third branched return passage 731, the first cooling valve 610, the pump part 500, the cooling passage 740, the cooling part 300, the cooling passage 740, the second cooling valve 630, the first branched water outlet passage 711, and the water outlet passage 710.

When the cooling mode is operated, the cooling part 300 is operated, and thus, it is required to dissipate heat of the cooling part 300 is required, and to achieve this, the first fan 430 and the second fan 440 may be operated to cool the cooling part 300 and the PBA module 140.

### Heating Mode

Next, referring to FIG. 3, the hot and cold water mat system 1 may be operated in a heating mode (or a heating system) when a temperature of the mat part 20 is to be increased. In FIG. 3, a path through which water circulates is indicated by a thick line, a path of water before being heated after being returned is indicated by a thick solid line, and a path of heated water is indicated by a thick dotted line.

When a temperature of the first internal passage is to be increased, the water returned through the first return passage 720 may be delivered to the second branched return passage 722 via the first return valve 650. That is, the first return valve 650 is operated such that the water in an interior of the first return passage 720 flows to the second branched return passage 722 connected to the first heating valve 620.

The water introduced into the second branched return passage 722 is delivered to the tank part 200 via the first heating valve 620 as the first heating valve 620 is opened, and, at this time, the first cooling valve 610 is in a closed state. The water delivered to the tank part 200 is heated to a predetermined temperature by the heater 230 in an interior of the tank part 200, and is then delivered to the pump part 500. The water delivered to the pump part 500 may be pumped by the pump part 500, and may be delivered to the second heating valve 640 through the heating passage 750.

The water delivered to the second heating valve 640 may flow through the second branched water outlet passage 712 and the water outlet passage 710 as the second heating valve 640 is opened, and may be discharged to the mat part 20. In this case, because the second cooling valve 630 is in a closed state, only the water that has been directly pumped from the pump part 500 while not passing through the cooling part 300 after being heated may be delivered to the water outlet passage 710. An outlet temperature sensor 810 provided in the water outlet passage 710 may measure a temperature of the discharged water. This is to prevent overheating of the discharged water.

That is, when a temperature of the first internal passage is to be increased, the water returned from the first internal passage is discharged to the mat part 20 after sequentially passing through the first return passage 720, the first return valve 650, the second branched return passage 722, the first heating valve 620, the tank part 200 (that is, the heater 230), the pump part 500, the heating passage 750, the second heating valve 640, the second branched water outlet passage 712, and the water outlet passage 710.

Likewise, even when a temperature of the second internal passage is to be increased, the water returned from the second internal passage is discharged again to the mat part 20 after sequentially passing through the second return passage 730, the second return valve 660, the fourth branched return passage 732, the first heating valve 620, the tank part 200 (that is, the heater 230), the pump part 500, the heating passage 750, the second heating valve 640, the second branched water outlet passage 712, and the water outlet passage 710.

Meanwhile, an operation of adjusting a temperature of the first internal passage and an operation of adjusting a temperature of the second internal passage may be performed simultaneously or may be performed sequentially. For example, when only a temperature of the first internal passage is adjusted, the water in the first internal passage may be circulated in a state, in which the water in the second internal passage does not circulate, by completely closing the second return valve 660.

Furthermore, the hot and cold water mat system 1 may be operated such that the first internal passage is cooled and the second internal passage is heated. In this case, the water in the first internal passage and the second internal passage is not circulated at the same time, and may be circulated sequentially. For example, an operation may be performed in a scheme of, when a temperature of the first internal passage is lowered and a temperature of the second internal passage is increased, supplying the cooled water to the first internal passage while being operated in the cooling mode in a state, in which the second return valve 660 is fully closed, and thereafter, supplying the heated water to the second internal passage while being operated in the heating mode in a state, in which the first return valve 650 is fully closed. In this case, an operation of supplying cooled water and an operation of supplying heated water may be alternately performed once until the temperature of the water reaches a preset temperature.

When the above-described hot and cold water mat system is operated in the cooling mode in a high-temperature and high-humidity environment, condensation may occur in the mat part, that is, the hot and cold water mat, and various problems may occur due to the generation of condensation.

The embodiments of the present disclosure are directed to preventing condensation of the hot and cold water mat by controlling a cooling part for cooling the water supplied from the hot and cold water mat system to the mat, and, through this, preventing in advance a problem caused by the condensation that occurs in a high-temperature and high-humidity environment.

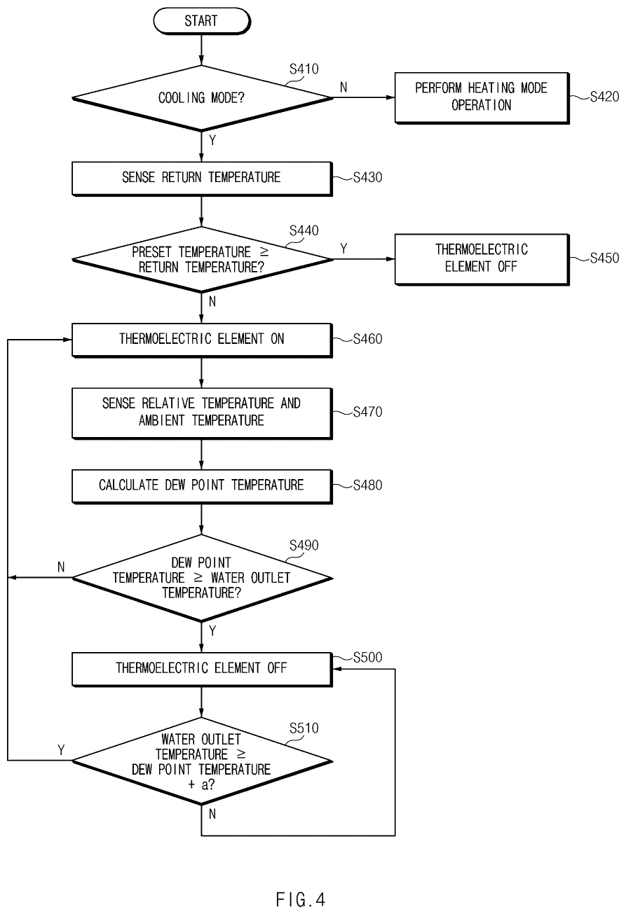

FIG. 4 illustrates a flow chart of operations of a method for controlling a hot and cold water mat according to an embodiment of the present disclosure.

Referring to FIG. 4, in the method for controlling the hot and cold water mat according to an embodiment of the present disclosure, it is determined whether the hot and cold water mat system is operated in a heating mode, and a heating mode operation is performed when it is operated in the heating mode (S410 and S420).

Here, the heating mode operation may be performed as the process described in FIG. 3.

In contrast, when the hot and cold water mat system is operated in the cooling mode in a determination result of operation S410, a return temperature, which is the temperature of water returned from the hot and cold water mat to the body part, is sensed by using a return temperature sensor (S430).

According to the embodiment, in operation S430, a temperature of the water returned to the first internal passage and a temperature of the water returned to the second internal passage may be sensed through the first return temperature sensor 820 and the second return temperature sensor 830, respectively. In this case, the return temperatures sensed by the first return temperature sensor 820 and the second return temperature sensor 830, respectively, may be different.

When the return temperature of the water returned to the body part is sensed in operation S430, it is determined whether a preset temperature set in the cooling mode of the hot and cold water mat system is the return temperature or higher by comparing the preset temperature and the return temperature.

According to the document, in operation S440, the preset temperature and the return temperature sensed by the first return temperature sensor 820 may be compared, and the preset temperature and the return temperature sensed by the second return temperature sensor 830 may be compared.

When it is determined that the preset temperature is equal to or higher than the return temperature in a determination result of operation S440, it is not necessary to further lower a temperature of the water that enters the hot and cold water mat, and thus, an operation of the thermoelectric element is stopped, that is, the thermoelectric element is turned off (S450).

According to the document, when the preset temperature is higher than both the return temperature sensed by the first return temperature sensor 820 and the return temperature sensed by the second return temperature sensor 830 in operation S450, the thermoelectric element may be turned off.

In contrast, when the return temperature is higher than the preset temperature in a determination result of operation S440, the thermoelectric element is operated, that is, the thermoelectric element is turned on to lower a temperature of the water that enters the hot and cold water mat, and a relative humidity and an ambient temperature of the hot and cold water mat system are sensed by using a temperature and humidity sensor 840 (S460 and S470).

According to the embodiment, in operation S460, when the preset temperature is higher than the return temperature sensed by the first return temperature sensor 820 and lower than the return temperature sensed by the second return temperature sensor 830, the thermoelectric element may be turned on to lower a temperature of the water that flows in the second internal passage of the hot and cold water mat after only the first return valve 650 is fully closed, and when the preset temperature is higher than the return temperature sensed by the second return temperature sensor 830 and lower than the return temperature sensed by the first return temperature sensor 820, the thermoelectric element may be turned on to lower a temperature of the water that flows in the first internal passage of the hot and cold water mat after only the second return valve 660 is fully closed

Of course, when the preset temperature is lower than both the return temperatures sensed by the first return temperature sensor 820 and the second return temperature sensor 830 in operation S460, the thermoelectric element may be turned on to lower a temperature of the water that flows in the first internal passage and the second internal passage of the hot and cold water mat while the first return valve 650 and the second return valve 660 are not closed.

When an external relative humidity and an ambient temperature of the hot and cold water mat system are sensed in operation S470, a dew point temperature is calculated by using the relative humidity and the ambient temperature (S480).

According to the embodiment, a dew point temperature may be calculated by substituting a relative humidity (x) into a preset calculation formula according to an ambient temperature (z), as shown in Table 1 below. Of course, in operation S480, any method capable of calculating a dew point temperature based on an ambient temperature and a relative humidity, other than the method of Table 1 below, may be used.

TABLE 1

| Ambient | Calculation of dew |
|---|---|
| temperature [z] | point temperature |
| 25 | y = −0.0013x² + 0.4186x − 3.6893 |
| 26 | y = −0.0013x² + 0.419x − 2.8119 |
| 27 | y = −0.0014x² + 0.4289x − 2.249 |
| 28 | y = −0.0013x² + 0.4235x − 1.2142 |
| 29 | y = −0.0014x² + 0.4359x − 0.7923 |
| 30 | y = −0.0014x² + 0.4412x − 0.0427 |
| 31 | y = −0.0014x² + 0.44x + 0.8058 |
| 32 | y = −0.0014x² + 0.4347x + 1.8716 |
| 33 | y = −0.0014x² + 0.4454x + 2.4869 |
| 34 | y = −0.0013x² + 0.437x + 3.6832 |
| 35 | y = −0.0014x² + 0.4954x + 4.1301 |

When a dew point temperature is calculated in operation S480, the dew point temperature and an outlet water temperature sensed by the outlet temperature sensor 810 are compared to determine whether the dew point temperature is the outlet water temperature or higher (S490).

When the dew point temperature is the outlet water temperature higher in a determination result of operation S490, the operated thermoelectric element is turned off because condensation may occur (S500). In contrast, when it is determined that the dew point temperature is lower than the outlet water temperature in a determination result of operation S490, a process of sensing a relative humidity and an ambient temperature while maintaining an operation state of the thermoelectric element, and a process of calculating the dew point temperature are repeatedly performed. That is, in the method according to an embodiment of the present disclosure, when the dew point temperature is calculated while the thermoelectric element is operated, an operation of the thermoelectric element may be maintained until the dew point temperature is higher than the outlet water temperature, and the operation of the thermoelectric element is stopped at a time point, at which the dew point temperature is the outlet water temperature or higher, so that condensation on the hot and cold water mat may be prevented.

In a state, in which the thermoelectric element is turned off in operation S500, it is determined whether the outlet water temperature “the dew point temperature+a” or higher, and when it is determined that the outlet water temperature is “the dew point temperature+a” or higher, the operation is fed back to the operation S460 of operating the thermoelectric element (S510).

Here, a is a preset value, and, for example, may be 1 degree. Of course, a value of a may be set differently depending on circumstances, and may vary depending on the outlet water temperature, the preset temperature, and the dew point temperature.

In contrast, in a determination result of operation S510, it is determined that the outlet water temperature is lower than “the dew point temperature+a”, and an off state of the thermoelectric element is maintained.

Although not illustrated in FIG. 4, when performing operation S510, a process of sensing a relative humidity and an ambient temperature and calculating a dew point temperature based on the relative humidity and the ambient temperature as in operations S470 and S480 may be performed, and through this process, the calculated dew point temperature and “the dew point temperature+a” may be compared.

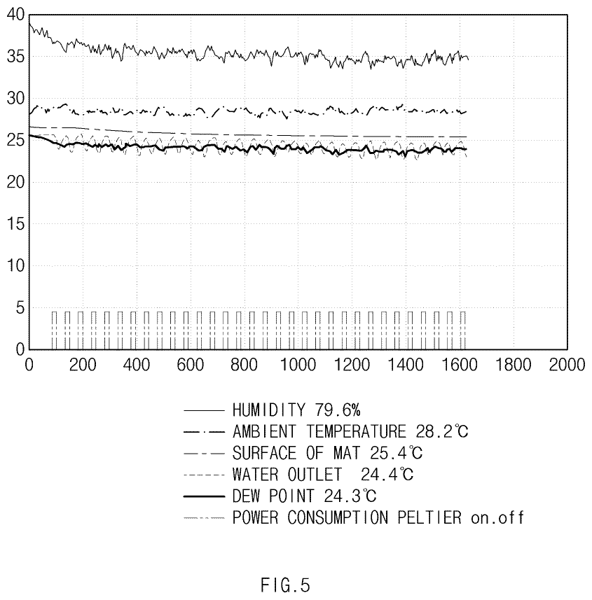

The method according to an embodiment of the present disclosure will be described below with reference to FIG. 5.

FIG. 5 illustrates an exemplary view for explaining a cooling part control scheme depending on a dew point temperature and an outlet water temperature.

As illustrated in FIG. 5, in the method according to an embodiment of the present disclosure, a relative humidity and an ambient temperature are sensed in real time at a humidity of around 79.6% and an ambient temperature of around 28.2 degrees, and a dew point temperature (for example, 24.3 degrees) is calculated based on the sensed relative humidity and ambient temperature in a state, in which the thermoelectric element, for example, a Peltier element, is on. Furthermore, a process of sensing an outlet water temperature (for example, 24.4 degrees), the Peltier element is turned off when the dew point temperature the outlet water temperature or higher, that is, when the Peltier element is operated and a temperature (the outlet water temperature) of the water that enters the hot and cold water mat is lowered, and sensing a relative humidity and an ambient temperature, and a process of calculating the dew point temperature based on this are performed in real time.

Because the Peltier element is in an off state, a temperature of the water that enters the hot and cold water mat (the outlet water temperature) is increased, and when the outlet water temperature is higher than the calculated dew point temperature by a predetermined temperature or higher, for example, 1 degree or higher, the Peltier element is operated (ON) again such that the outlet water temperature is lowered to prevent condensation. By repeatedly performing the process, the outlet water temperature may be prevented from being lower than the dew point temperature by a predetermined temperature or higher while the outlet water temperature may be prevented from being higher than the dew point temperature by a predetermined temperature or higher.

In this way, in the method for controlling the hot and cold water mat according to an embodiment of the present disclosure, condensation of the hot and cold water mat may be prevented by controlling a cooling part for cooling water supplied to the hot and cold water mat, for example, the thermoelectric element including the Peltier element.

Furthermore, the method for controlling the hot and cold water mat according to an embodiment of the present disclosure may prevent a problem that may be caused by condensation in advance by preventing condensation in a high-temperature and high-humidity environment.

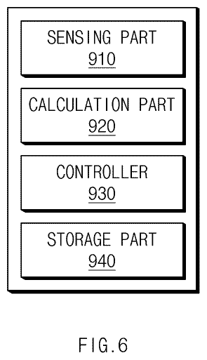

FIG. 6 illustrates a configuration of a hot and cold water mat control apparatus according to another embodiment of the present disclosure, and conceptually illustrates a configuration of an apparatus that performs the methods of FIGS. 4 and 5.

Referring to FIG. 6, a hot and cold water mat control apparatus 900 according to another embodiment of the present disclosure includes a sensing part 910, a calculation part 920, a controller 930, and a storage part 940.

The storage part 940 serves as a means for storing all data related to the technology of the present disclosure, and stores various types of data associated with the technology of the present disclosure, including an algorithm corresponding to the method of the present disclosure, the data of Table 1, sensing data, and control algorithms for cooling and heating modes.

The sensing part 910 senses a return temperature of water returned from the hot and cold water mat, an outlet water temperature of water discharged to the hot and cold water mat, and an external relative humidity and an ambient temperature of the hot and cold water mat system.

According to the embodiment, the sensing part 910 may include the outlet temperature sensor 810, the first return temperature sensor 820, the second return temperature sensor 830, and the temperature and humidity sensor 840 illustrated in FIGS. 1 to 3.

The calculation part 920 calculates a dew point temperature based on a relative humidity and an ambient temperature sensed by the sensing part 910.

The controller 930 compares a return temperature and a preset temperature, performs a control to operate a cooling part for cooling water supplied to the hot and cold water mat when it is determined that the return temperature is higher than the preset temperature, compares a dew point temperature and an outlet water temperature, and performs a control to stop an operation of the cooling part when it is determined that the dew point temperature is lower than the outlet water temperature.

According to the document, according to the embodiment, the controller 930 may perform a control to operate the cooling part when the hot and cold water mat system is operated in the cooling mode and it is determined that the return temperature is higher than the preset temperature.

According to the embodiment, the controller 930 may perform a control to operate the cooling part when it is determined that the outlet water temperature is higher than the dew point temperature by a predetermined temperature or higher.

Even though the description is omitted in the apparatus according to another embodiment of the present disclosure, it will be apparent to those skilled in the art that the apparatus according to another embodiment of the present disclosure may include all of the contents described in FIGS. 1 to 5, and this will be obvious to those skilled in the art.

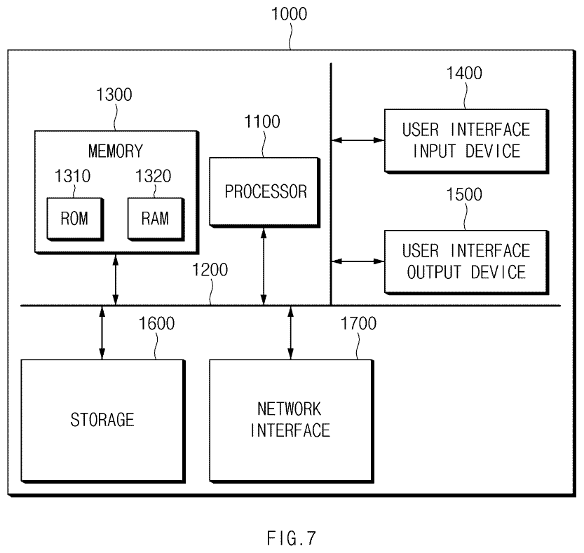

FIG. 7 illustrates a block diagram of a computing system for executing a method for controlling a hot and cold water mat according to an embodiment of the present disclosure.

Referring to FIG. 8, the method for controlling the hot and cold water mat according to an embodiment of the present disclosure described above may also be implemented through a computing system. A computing system 1000 may include at least one processor 1100, a memory 1300, a user interface input device 1400, a user interface output device 1500, storage 1600, and a network interface 1700, which are connected with each other through a system bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) 1310 and a random access memory (RAM) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM. The storage medium may be coupled to the processor 1100. The processor 1100 may read out information from the storage medium and may write information in the storage medium. Alternatively, the storage medium may be integrated with the processor 1100. The processor 1100 and storage medium may be implemented with an application specific integrated circuit (ASIC). The ASIC may be provided in a user terminal. Alternatively, the processor 1100 and storage medium may be implemented with separate components in the user terminal.

According to the present disclosure, condensation of the hot and cold water mat may be prevented by controlling the thermoelectric element including the cooling part, for example, the Peltier element, for cooling water supplied to the mat.

According to the present disclosure, condensation may be prevented in a high-temperature and high-humidity environment, so that a problem that may be caused by the condensation may be prevented in advance.

Effects obtained in the present disclosure are not limited to the above-mentioned effects, and other effects that are not mentioned will be clearly understood by those skilled in the art, to which the present disclosure belongs, from the following description.

The above description is merely an example of the technical idea of the present disclosure, and various modifications and variations may be made by one skilled in the art without departing from the essential characteristic of the present disclosure. Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

What is claimed is:

1. A method for controlling a hot and cold water mat, the method comprising:
comparing a return temperature and a preset temperature, and operating a cooling part for cooling water supplied to the mat when it is determined that the return temperature is higher than the preset temperature;
sensing a relative humidity and an ambient temperature, and calculating a dew point temperature by using the relative humidity and the ambient temperature; and
comparing the dew point temperature and an outlet water temperature, and stopping an operation of the cooling part when it is determined that the dew point temperature is lower than the outlet water temperature.

2. The method of claim 1, wherein in the operating of the cooling part, the hot and cold water mat is operated in a cooling mode, and the cooling part is operated when it is determined that the return temperature is higher than the preset temperature.

3. The method of claim 1, further comprising:
operating the cooling part when it is determined that the outlet water temperature is higher than the dew point temperature by a predetermined temperature or more.

4. The method of claim 1, wherein the cooling part includes a thermoelectric element.

5. The method of claim 4, wherein the thermoelectric element includes a Peltier element.

6. A hot and cold water mat control apparatus comprising:
a memory configured to store computer-executable instructions; and
at least one processor configured to execute the instructions by accessing the memory,
wherein the at least one processor is configured to:
compare a return temperature and a preset temperature, and operate a cooling part for cooling water supplied to the mat when it is determined that the return temperature is higher than the preset temperature;
sense a relative humidity and an ambient temperature, and calculate a dew point temperature by using the relative humidity and the ambient temperature; and
compare the dew point temperature and an outlet water temperature, and stop an operation of the cooling part when it is determined that the dew point temperature is lower than the outlet water temperature.

7. The hot and cold water mat control apparatus of claim 6, wherein the at least one processor is configured to:
operate the hot and cold water mat in a cooling mode, and operate the cooling part when it is determined that the return temperature is higher than the preset temperature.

8. The hot and cold water mat control apparatus of claim 6, wherein the at least one processor is configured to:
operate the cooling part when it is determined that the outlet water temperature is higher than the dew point temperature by a predetermined temperature or more.

9. The hot and cold water mat control apparatus of claim 6, wherein the cooling part includes a thermoelectric element.

10. The hot and cold water mat control apparatus of claim 9, wherein the thermoelectric element includes a Peltier element.
